(19) United States
(12) Patent Application Publication
(10) Pub. No.: US 2005/0276434 A1
(43) Pub. Date: Dec. 15, 2005

(54) Dynamic exciter and loudspeaker using the same

(75) Inventors: Takashi Kobayashi, Fujiyoshida-shi (JP); Kazuhiro Kobayashi, Fujiyoshida-shi (JP)

Correspondence Address: BRINKS HOFER GILSON & LIONE, P.O. BOX 10395, CHICAGO, IL, 60610, US

(73) Assignee: Citizen Electronics Co., Ltd.

(21) Appl. No.: 11/148,646

(22) Filed: Jun. 9, 2005

(30) Foreign Application Priority Data
Jun. 9, 2004 (JP) JP2004-171575

(51) Int. Cl. H04R 25/00

(52) U.S. Cl. 381/396

(57) ABSTRACT

A dynamic exciter includes a frame, a magnetic circuit assembly, which includes a permanent magnet and a yoke and through which a magnetic circuit generated by the permanent magnet extends, and an electromagnetic coil positioned across a magnetic gap formed in the magnetic circuit assembly. A first suspension member supportingly connects the magnetic circuit assembly to the frame member. A second suspension member supportingly connects the electromagnetic coil to the frame member. The frame is adapted to be attached to a diaphragm of a loudspeaker. The exciter has two mechanical resonance systems through which vibrations are transmitted to the frame: one being formed by the magnetic circuit assembly and the first suspension member and the other being formed by the electromagnetic coil and the second suspension member.

This application claims priority under 35 U.S.C. § 119 to Japanese Patent Application No. 2004-171575 filed Jun. 9, 2004, the entire content of which is hereby incorporated by reference.

### BACKGROUND OF THE INVENTION

1. Field of the Invention

The present invention generally relates to loudspeakers for use in personal computers, PDAs, cellular phones and other miniature devices and, more particularly, to dynamic exciters incorporated into loudspeakers.

2. Description of the Related Arts

Loudspeakers suitable for use in such miniature devices include a dynamic exciter, as disclosed, for example, in Japanese Patent Application Publication No. 2003-143690. FIG. 5 is a sectional view of such a dynamic exciter 500.

The dynamic exciter 500 comprises a cylindrical frame member 502, an electromagnetic coil 503 secured to the upper end wall of the cylindrical frame member 502, a permanent magnet 504 having polarized upper and lower ends, a disc-like inner yoke 505 secured to the polarized upper end of the magnet 504, and a cylindrical outer yoke 506 with the bottom wall thereof secured to the polarized lower end of the magnet 504. The inner yoke 505 and the outer yoke 506 are both formed from a metal of high permeability. The inner yoke 505, the magnet 504 and the outer yoke 506 constitute a magnetic circuit assembly 508. An annular magnetic gap is formed between the inner yoke 505 and the outer yoke 506 of the magnet circuit assembly 508.

An annular suspension member or annular leaf spring 507 is provided between the frame member 502 and the outer yoke 506 so that the frame member 502 elastically supports the magnetic circuit assembly 508. The electromagnetic coil 503 extends into the annular magnetic gap formed between the inner yoke 505 and the outer yoke 506.

In FIG. 5, reference numeral 601 denotes a diaphragm of a loudspeaker. The dynamic exciter 500 is adapted to be secured to the diaphragm 601 through the frame member 502.

In the dynamic exciter 500, when an electric current is applied to the electromagnetic coil 503, electromagnetic force is generated between the electromagnetic coil 503 and the magnetic circuit assembly 508, so that the diaphragm 601 is exited and generates a sound output.

The dynamic exciter 500 is compact and suitable for use in a loudspeaker for miniature devices such as personal computers, PDAs, and cellular phones.

However, the dynamic exciter 500 suffers from the following problems:

As noted from the above, the dynamic exciter 500 has a single mechanical resonance system consisting of a mass and a spring, i.e., a mass of the magnetic circuit assembly 508 including the magnet 504 and the yokes 505 and 506, and a spring of the suspension member 507 elastically supporting the mass or the magnetic circuit assembly 508.

FIG. 6 is a sound pressure level/frequency chart in which horizontal and vertical axes represent frequency and sound pressure level, respectively. A curve T1 in the chart is a frequency characteristic curve of a loudspeaker incorporating the dynamic exciter 500. A curve T0 represents frequency characteristics desired for a loudspeaker in which the sound pressure level is generally kept constant over a generally entire frequency range of the loudspeaker.

The characteristic curve T1 apparently deviates from the desired characteristic curve T0. Namely, the characteristic curve T1 has a steep peak in the low-frequency range and shows low sound pressure levels in the high-frequency range. The steep peak in the curve T1 generally corresponds to the resonance frequency of the above-described single mechanical resonance system in the dynamic exciter 500.

Although it is desired to regulate the dynamic exciter to lessen such a deviate of the characteristic curve T1 from the characteristic curve T0, it is difficult or substantially impossible for the exciter having only a single mechanical resonance system to effect such a modulation.

### SUMMARY OF THE INVENTION

An object of the present invention is to provide a dynamic exciter and a loudspeaker with a dynamic exciter, the dynamic exciter having frequency characteristics in which the amplitude of vibrations or sound pressure level is generally kept constant in a wide frequency range including a low frequency range and a high frequency range.

According to the present invention, a dynamic exciter includes a frame member adapted to be attached to a diaphragm of a loudspeaker; a permanent magnet having an axis and polarized opposite ends in a direction of the axis, an electromagnetic coil positioned across the magnetic circuit; a first suspension member supportingly connecting the permanent magnet to the frame member; and a second suspension member supportingly connecting the electromagnetic coil to the frame member. Namely, the dynamic exciter is characterized in that it includes two resonance systems, i.e., one comprising the first suspension member and the permanent magnet and the other comprising the second suspension member and the electromagnetic coil.

Specifically, the dynamic exciter may comprise a yoke connected to the permanent magnet so that the yoke and permanent magnet constitute a magnet circuit assembly through which the magnetic circuit generated by the permanent magnet extends. The first suspension member supportingly connects the magnetic circuit assembly to the frame member.

The yoke may comprise a disc-like inner yoke secured to one of the polarized opposite ends of the permanent magnet, and a cylindrical outer yoke having an end wall secured to the other of the polarized opposite ends of the permanent magnet. The cylindrical outer yoke extends in the direction of the axis of the magnet and surrounds the permanent magnet and the disc-like inner yoke to form the magnetic gap in an annular shape between the disc-like inner yoke and the cylindrical outer yoke. The first suspension member is connected between the cylindrical outer yoke and the frame member. The electromagnetic coil extends in the direction of the axis into the magnetic gap.

Specifically, the frame member may be cylindrical and extended in the direction of the axis of the magnet, outside the cylindrical outer yoke. At least one of the first and second suspension members may be an annular leaf spring member disposed inside the frame member, the annular leaf spring member extending transversely relative the axis of the magnet. The annular leaf spring member may have a plurality of slits which extend radially inwardly from a radially outer portion thereof and are circumferentially arranged. The annular leaf spring member may be formed to have concentric corrugations.

When the dynamic exciter is installed in a casing of a loudspeaker, which has an opening closed by a diaphragm, the dynamic exciter is attached to the diaphragm through the frame member. It is preferable for the magnetic circuit assembly is engaged with or connected to a yieldable member mounted on a wall of the casing of the loudspeaker which wall is positioned opposite to the opening so as to properly limit the vibration of the magnetic circuit assembly. The yieldable member may be made of a spongy material.

The above and other objects, features and advantages of the present invention will become more apparent from the following description of the preferred embodiments thereof, taken in conjunction with the accompanying drawings.

### BRIEF DESCRIPTION OF THE DRAWINGS

FIG. 1 is a sectional view of a dynamic exciter according to the present invention.

FIG. 2 is a sectional view of a loudspeaker incorporating the dynamic exciter of FIG. 1.

FIG. 3 is an exploded perspective view showing constituent elements of the dynamic exciter of FIG. 1.

FIG. 4A is a perspective view showing a modified suspension member which may be used in the dynamic exciter of FIG. 1.

FIG. 4B is a sectional view of the suspension member of FIG. 4A.

FIG. 5 is a sectional view of a conventional dynamic exciter.

FIG. 6 is a characteristic chart showing frequency characteristics of loudspeakers.

### DESCRIPTION OF THE PREFERRED EMBODIMENTS

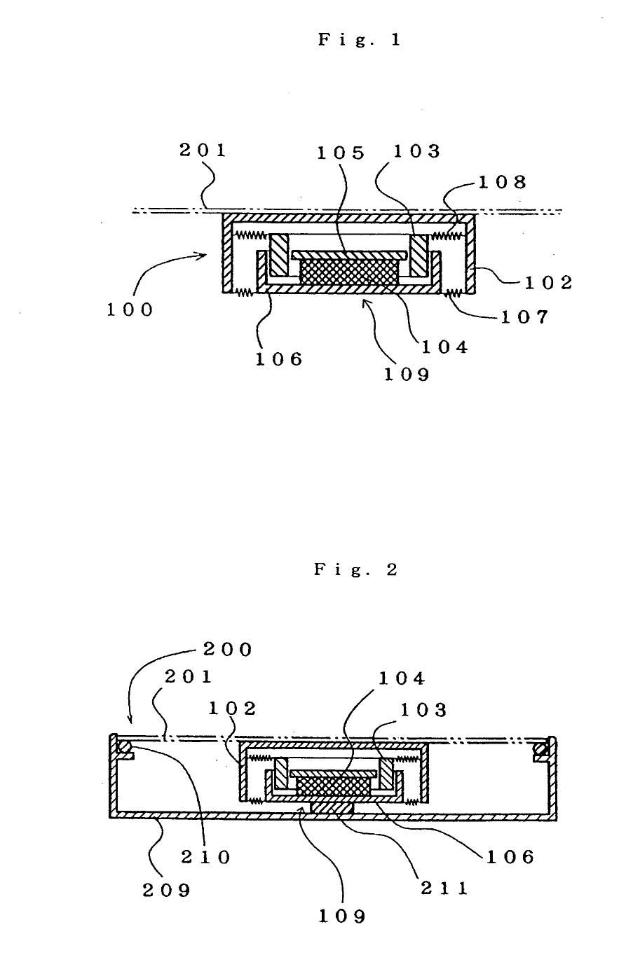

With reference to FIGS. 1 to 4B, a dynamic exciter 100 according to an embodiment of the present invention has a frame member 102, an electromagnetic coil 103, and a permanent magnet 104 having polarized vertical opposite ends. The frame member 102, the electromagnetic coil 103 and the magnet 104 are concentrically arranged about a vertical center axis of the magnet 104. A disc-like inner yoke 105 is secured to the upper end of the magnet 104 and a cylindrical outer yoke 106 is secured to the lower end of the magnet 104. The inner yoke 105 and the outer yoke 106 are both formed from a metal of high permeability and cooperate with the magnet 104 to constitute a magnetic circuit assembly 109 through which a magnetic circuit generated by the magnet 104 extends. A first annular suspension member or annular leaf spring 107 is provided between the outer yoke 106 and the frame member 102 so as to supportingly connect the magnetic circuit assembly 109 to the frame member 102. A second annular suspension member or annular leaf spring 108 is provided between the electromagnetic coil 103 and the frame member 102 so as to supportingly connect the electromagnetic coil 103 to the frame member 102. The electromagnetic coil 103 extends vertically through an annular magnetic gap formed between the inner yoke 105 and the outer yoke 106 of the magnetic circuit assembly 9.

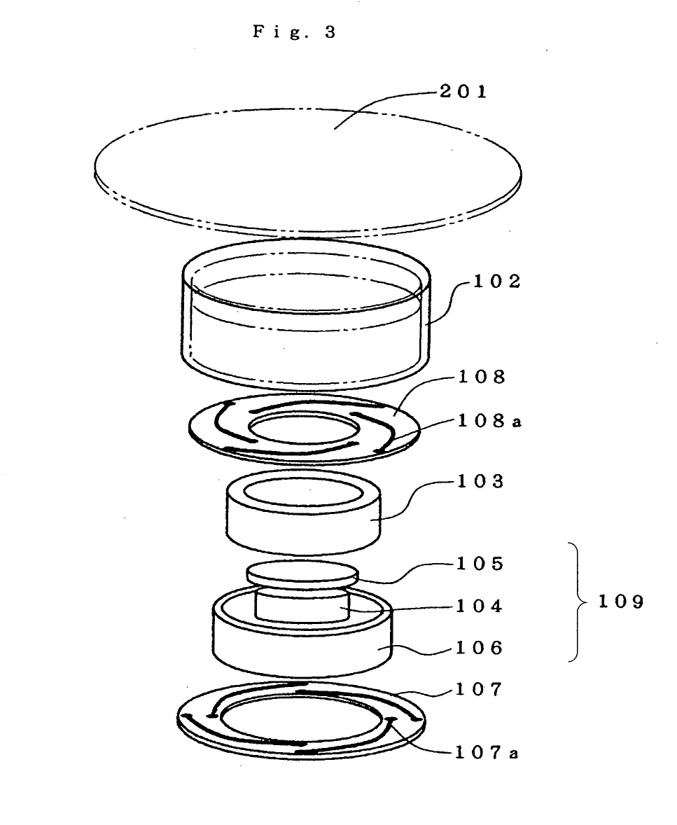

In the illustrated embodiment, the first and second suspension members 107 and 108 are formed from a resin sheet material, a cloth impregnated with resin, a metal sheet material, or a combination of these materials and, as shown in FIG. 3, are respectively provided with slits 107a and 108a curving and extending outwardly from respective radially inward portions thereof. The slits 107a (108a) are arranged in a circumferentially spaced relationship. Accordingly, the suspension members 107 and 108 have a sufficient degree of elasticity in the direction of the center axis thereof, while being substantially rigid in the radial direction. The second suspension member 108 is secured to the cylindrical frame member 102 at a position close to the upper end of the latter by bonding, welding and etc. The first suspension member 107 is secured to the lower end of the frame member 102 by bonding, welding and etc.

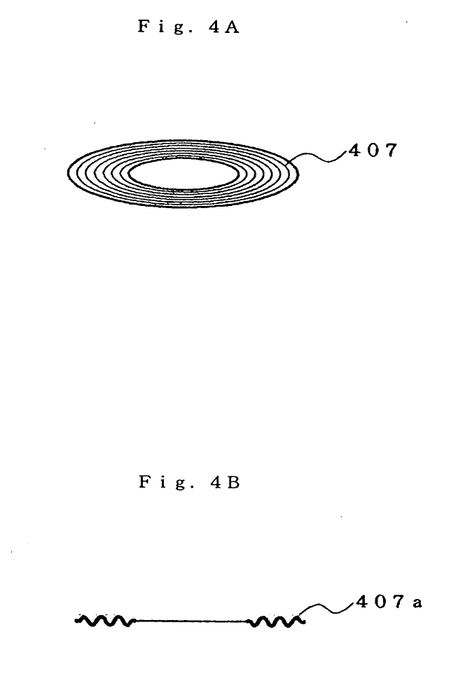

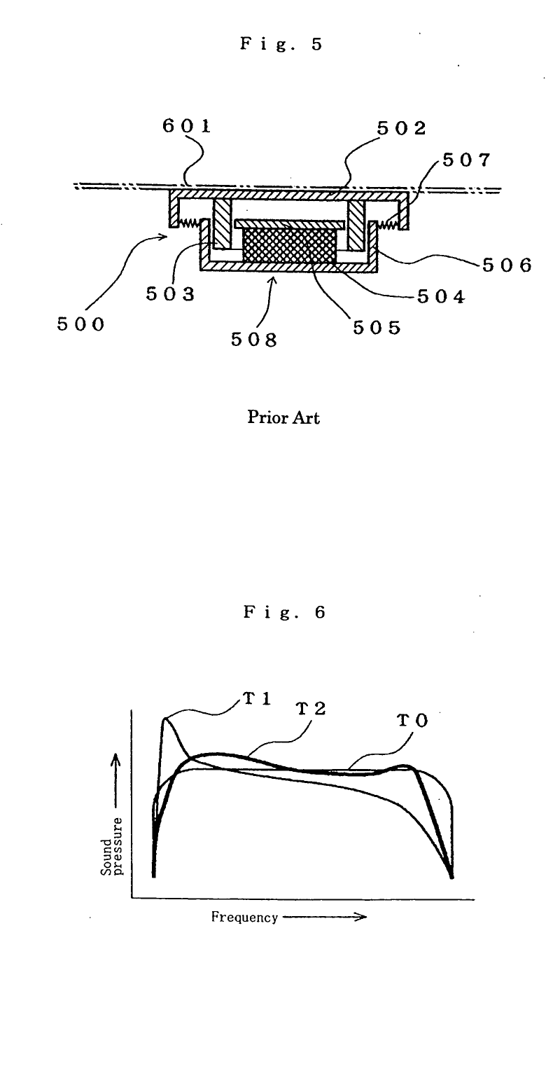

FIGS. 4A and 4B show a modified suspension member 407. The suspension member 407 is in the form of an annular leaf spring formed from a resin sheet material, a cloth impregnated with a resin, a metal sheet material, or a combination of these materials. The suspension member 407 is formed to have concentric corrugations 407a. Accordingly, the suspension member 407 may be more elastic in the axial direction than the suspension members 107 and 108.

The dynamic exciter 100 is adapted to be secured through the frame member 102 to a diaphragm 201 of a loudspeaker as will be described later.

In the dynamic exciter 100 described above, there are formed two mechanical resonance systems each consisting of a mass and a spring, i.e., a first mechanical resonance system having the first suspension member 107 as a spring and the magnetic circuit assembly 109 as a mass, and a second mechanical resonance system having the second suspension member 108 as a spring and the electromagnetic coil 103 as a mass. The first and second mechanical resonance systems respectively have predetermined natural frequencies which are different from each other.

An operation of the dynamic exciter 100 will be hereinbelow explained.

When an electric current flows through the electromagnetic coil 103, an electromagnetic force is generated between the electromagnetic coil 103 and the magnetic circuit assembly 109 so as to vibrate the electromagnetic coil 103 and the magnetic circuit assembly 109. The vibrations of the electromagnetic coil 103 and the magnetic circuit assembly 109 are transmitted through the first and second suspension members 107 and 108 to the frame member 102. Accordingly, the diaphragm 201 of a loudspeaker provided on the frame member 102 is vibrated to generate an acoustic signal.

Namely, according to the illustrated embodiment, the dynamic exciter 100 excites the diaphragm 201 of the loudspeaker through the two mechanical resonance systems thereof, i.e., the first mechanical resonance system having the first suspension member 107 and the magnetic circuit assembly 109, and the second mechanical resonance system having the second suspension member 108 and the electromagnetic coil 103.

In general, the magnetic circuit assembly 109 has a large mass because of its material, whereas the electromagnetic coil 103 has a small mass. Therefore, the first mechanical resonance system including the magnetic circuit assembly 109 has a natural frequency in a lower-frequency range, while the second mechanical resonance system including the electromagnetic coil 103 has a natural frequency in a higher-frequency range. The first and second mechanical resonance systems cooperate with each other to allow the frequency characteristic curve of the dynamic exciter to be generally flat over a wide frequency range including the low-frequency range and the high-frequency range. Advantageously, the frequency characteristics of the first and second mechanical resonance systems can be adjusted independently of each other so as to improve the frequency characteristics of the dynamic exciter 100.

In FIG. 6, a curve T2 represents the frequency characteristics of a loudspeaker 200 shown in FIG. 2. The loudspeaker 200 has a casing 209 with an opening formed at the top thereof being closed by the diaphragm 201, to which the dynamic exciter 100 is, as described above, attached through the frame member 102. The peripheral edge of the diaphragm 201 is connected to the casing 209 through an yieldable member 210 made, for example, of a sponge, rubber, or a silicone or rubber adhesive so that the diaphragm can appropriately move. The magnetic circuit assembly 109 of the dynamic exciter 100 is connected to or engaged with a sponge 211 made of rubber or other yieldable materials secured on the bottom wall of the casing 209 so that the vibration of the dynamic exciter 100 is properly limited.

As can be seen from FIG. 6, the curve T2 is similar to the desired curve T0 as compared with T1. Namely, the frequency characteristics of the loudspeaker 200 have been improved in both of the high-level frequency range and the low-level frequency range.

Although the present invention has been described in terms of specific embodiments, it is anticipated that alternations and modifications thereof will no doubt become apparent to those skilled in the art. It is therefore intended that the following claims be interpreted as covering all such alternations and modifications as fall within the true sprit and scope of the invention.

1. A dynamic exciter comprising:
a frame member adapted to be attached to a diaphragm of a loudspeaker;
a permanent magnet having an axis and polarized opposite ends in a direction of said axis, said permanent magnet generating a magnetic circuit;
an electromagnetic coil positioned across said magnetic circuit;
a first suspension member supportingly connecting said permanent magnet to said frame member; and
a second suspension member supportingly connecting said electromagnetic coil to said frame member.

2. A dynamic exciter according to claim 1 further comprising
a yoke connected to said permanent magnet, said yoke and permanent magnet constituting a magnetic circuit assembly through which said magnetic circuit extends, said yoke having a magnetic gap therein,
wherein said first suspension member supportingly connects said magnetic circuit assembly to said frame member.

3. A dynamic exciter according to claim 2, wherein
said yoke comprises
a disc-like inner yoke secured to one of said polarized opposite ends of said permanent magnet, and
a cylindrical outer yoke having an end wall secured to the other of said polarized opposite ends of said permanent magnet, said outer yoke extending in said direction of said axis and surrounding said permanent magnet and said disc-like inner yoke to form said magnetic gap in an annular shape between said disc-like inner yoke and said cylindrical outer yoke;
said first suspension member is connected between said cylindrical outer yoke and said frame member; and,
said electromagnetic coil extends in said direction of said axis into said magnetic gap.

4. A dynamic exciter according to claim 3 wherein
said frame member is cylindrical and extends in said direction outside said cylindrical outer yoke; and,
at least one of said first and second suspension members is an annular leaf spring member disposed inside said frame member, said annular leaf spring member extending transversely relative said axis.

5. A dynamic exciter according to claim 4 wherein
said annular leaf spring member has a plurality of slits extending radially inward from a radially outer portion thereof, said slits being circumferentially arranged.

6. A dynamic exciter according to claim 4 wherein
said annular leaf spring member is formed to have concentric corrugations.

7. A loudspeaker comprising:
a casing having an opening;
a diaphragm extending across said opening of said casing; and,
a dynamic exciter for exciting said diaphragm, comprising:
a frame member attached to said diaphragm;
a permanent magnet having an axis said diaphragm and polarized opposite ends in a direction of said axis, said permanent magnet generating a magnetic circuit;
an electromagnetic coil positioned across said magnetic circuit;
a first suspension member supportingly connecting said permanent magnet to said frame member; and
a second suspension member supportingly connecting said electromagnetic coil to said frame member.

8. A loudspeaker according to claim 7 wherein said exciter further comprises:
a yoke connected to said permanent magnet, said yoke and permanent magnet constituting a magnetic circuit assembly through which said magnetic circuit extends, said yoke having a magnetic gap therein,
said first suspension member supportingly connecting said magnetic circuit assembly to said frame member.

9. A loudspeaker according to claim 8 wherein:
said yoke comprises
a disc-like inner yoke secured to one of said polarized opposite ends of said permanent magnet, and
a cylindrical outer yoke having an end wall secured to the other of said polarized opposite ends of said permanent magnet, said outer yoke extending in said direction of said axis and surrounding said permanent magnet and said disc-like inner yoke to form said magnetic gap in an annular shape between said cylindrical outer yoke and said disc-like inner yoke;
said first suspension member is connected between said cylindrical outer yoke and said frame member; and,
said electromagnetic coil extends in said direction of said axis into said magnetic gap.

10. A loudspeaker according to claim 9 wherein:
said frame member is cylindrical and extends in said direction outside said cylindrical outer yoke; and,
at least one of said first and second suspension members is an annular leaf spring member disposed inside said frame member, said annular leaf spring member extending transversely relative said axis.

11. A loudspeaker according to claim 10 wherein:
said annular leaf spring member has a plurality of slits extending radially inward from a radially outer portion thereof, said slits being circumferentially arranged.

12. A loudspeaker according to claim 10, wherein:
said annular leaf spring member is formed to have concentric corrugations.

13. A loudspeaker according to claim 7, further comprising a yieldable member secured on said casing and engaged with said magnetic circuit assembly.

14. A loudspeaker according to claim 13, wherein said yieldable member is made of a spongy material.
